(19) United States
(12) Patent Application Publication
(10) Pub. No.: US 2025/0294576 A1
(43) Pub. Date: Sep. 18, 2025

(54) RESOURCE ALLOCATION ON MULTIPLE CHANNELS

(71) Applicant: Lenovo (United States) Inc., Morrisville, NC (US)

(72) Inventors: Khaled Nafez Rauf Ardah, Ilmenau (DE); Karthikeyan Ganesan, Nauheim (DE); Ali Ramadan Ali, Kraiburg am Inn (DE)

(21) Appl. No.: 19/224,664

(22) Filed: May 30, 2025

(51) Int. Cl. H04W 72/231; H04L 5/00; H04L 5/14; H04W 72/044; H04W 72/51

(52) U.S. Cl. CPC H04W 72/231; H04L 5/0044; H04L 5/14; H04W 72/044; H04W 72/51

(57) ABSTRACT

Various aspects of the present disclosure relate to receiving a first downlink control information (DCI), wherein the first DCI indicates a first resource allocation of a first set of resources for reception of a physical downlink shared channel (PDSCH), and wherein the first DCI further is indicative of a second resource allocation of a second set of resources for transmission of at least one or multiple physical uplink shared channel (PUSCH), and transmitting the at least one or multiple PUSCH using the second set of resources.

### TECHNICAL FIELD

The present disclosure relates to wireless communications, and more specifically to techniques for communicating (e.g., transmitting, receiving) downlink control information (DCI) for resource allocation on multiple channels.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies (RATs) including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to receive a first DCI, wherein the first DCI indicates a first resource allocation of a first set of resources for reception of a physical downlink shared channel (PDSCH), and wherein the first DCI further is indicative of a second resource allocation of a second set of resources for transmission of at least one or multiple physical uplink shared channel (PUSCH); and transmit the at least one or multiple PUSCH using the second set of resources.

A processor (e.g., a standalone processor chipset, or a component of a UE) for wireless communication is described. The processor may be configured to, capable of, or operable to receive a first DCI, wherein the first DCI indicates a first resource allocation of a first set of resources for reception of a PDSCH, and wherein the first DCI further is indicative of a second resource allocation of a second set of resources for transmission of at least one or multiple PUSCH; and transmit the at least one or multiple PUSCH using the second set of resources.

A method performed or performable by a UE is described. The method may include receiving a first DCI, wherein the first DCI indicates a first resource allocation of a first set of resources for reception of a PDSCH, and wherein the first DCI further is indicative of a second resource allocation of a second set of resources for transmission of at least one or multiple PUSCH; and transmitting the at least one or multiple PUSCH using the second set of resources.

A NE for wireless communication is described. In some examples, the NE may be implemented in a base station. The NE may be configured to, capable of, or operable to transmit a first DCI to a UE, wherein the first DCI indicates a first resource allocation of a first set of resources for reception of a PDSCH, and wherein the first DCI further is indicative of a second resource allocation of a second set of resources for at least one or multiple PUSCH; and receive the at least one or multiple PUSCH using the second set of resources.

A processor (e.g., a standalone processor chipset, or a component of a UE) for wireless communication is described. In some examples, the processor may be implemented in a base station. The processor may be configured to, capable of, or operable to transmit a first DCI to a UE, wherein the first DCI indicates a first resource allocation of a first set of resources for reception of a PDSCH, and wherein the first DCI further is indicative of a second resource allocation of a second set of resources for at least one or multiple PUSCH; and receive the at least one or multiple PUSCH using the second set of resources.

A method performed or performable by a NE is described. In some examples, the NE may be implemented in a base station. The method may include transmitting a first DCI to a UE, wherein the first DCI indicates a first resource allocation of a first set of resources for reception of a PDSCH, and wherein the first DCI further is indicative of a second resource allocation of a second set of resources for at least one or multiple PUSCH; and receiving the at least one or multiple PUSCH using the second set of resources.

### BRIEF DESCRIPTION OF THE DRAWINGS

FIG. 1 illustrates an example of a wireless communications system in accordance with aspects of the present disclosure.

FIG. 2 illustrates an example of a time division duplex (TDD) communication scheme for transmission of a first DCI that indicates a second DCI is present in a PDSCH, in accordance with aspects of the present disclosure.

FIG. 3 illustrates an example of a subband full-duplex (SBFD) communication scheme for transmission of a first DCI that indicates a second DCI is present in a PDSCH, in accordance with aspects of the present disclosure.

FIG. 4 illustrates another example of a SBFD communication scheme for transmission of a first DCI that indicates a second DCI is present in a PDSCH, in accordance with aspects of the present disclosure.

FIG. 5 illustrates another example of a SBFD communication scheme for transmission of a first DCI that indicates a second DCI is present in a PDSCH, in accordance with aspects of the present disclosure.

FIG. 6 illustrates an example of a TDD communication scheme for transmission of a DCI that indicates or schedules communication resources on multiple channels, in accordance with aspects of the present disclosure.

FIG. 7 illustrates an example of a SBFD communication scheme for transmission of a DCI that indicates or schedules communication resources on multiple channel, in accordance with aspects of the present disclosure.

FIG. 8 illustrates an example of a protocol stack, in accordance with aspects of the present disclosure.

FIG. 9 illustrates an example of a UE, in accordance with aspects of the present disclosure.

FIG. 10 illustrates an example of a processor, in accordance with aspects of the present disclosure.

FIG. 11 illustrates an example of a NE, in accordance with aspects of the present disclosure.

FIG. 12 illustrates a flowchart of a method performed by a UE, in accordance with aspects of the present disclosure.

FIG. 13 illustrates a flowchart of a method performed by an NE, in accordance with aspects of the present disclosure.

### DETAILED DESCRIPTION

In wireless communication systems, such as 5G new radio (NR), the network (e.g., a base station) may support dynamic resource allocation (e.g., scheduling) of downlink (DL) PDSCH reception and uplink (UL) PUSCH transmission, and provide (e.g., transmit, indicate) the resource allocation to a UE using different DCI formats, wherein each DCI format is carried via a physical downlink control channel (PDCCH) that is transmitted on a configured search space of a configured control resource set (CORESET). For each DCI format, a cyclic redundancy check (CRC) is appended (e.g., attached) to DCI payload, where the CRC is scrambled by a specific radio network temporary identifier (RNTI) and the RNTI used depends on the purpose of the DCI. For example, a DCI for scheduling a PDSCH for a random access response (RAR) is scrambled by a random-access RNTI (RA-RNTI), a DCI for scheduling a UE-specific PDSCH or PUSCH is scrambled by a cell-RNTI (C-RNTI), etc.

In some wireless communication systems, the network (e.g., the base station) does not explicitly indicate the DCI format and/or the resource allocation (e.g., specific resources) for receiving a DCI to the UE. Instead, the UE may be configured with a number of PDCCH candidates on one or more search spaces to monitor for one or more DCI (e.g., one or more transmissions of DCI). Within those PDCCH candidates, the UE may perform blind decoding to attempt to decode a DCI. As a result, this blind decoding approach imposes significant processing effort (e.g., decoding time) and power demands on the UE.

Aspects of the present disclosure describe DCI-based scheduling of resources for DL PDSCH reception and/or UL PUSCH transmission. Beneficially, the techniques described herein reduce the processing effort (e.g., decoding time) and provide power saving benefits (e.g., reduce energy consumption) to the UE.

According to one aspect of the present disclosure, a first DCI (e.g., a new format, an enhancement of a legacy format, or an extension of a legacy format) may be used to schedule a first set of resources for a first PDSCH. Additionally, the first DCI may indicate, or be indicative of, the presence of additional scheduling information (e.g., a second DCI) embedded within the first PDSCH. The additional scheduling information may be used to schedule a second set of resources, such as for one or multiple PUSCH, or for at least one second PDSCH. Beneficially, upon decoding the first DCI, the UE may identify (e.g., become aware) that the additional scheduling information is included (e.g., embedded, carried) in the first PDSCH. As a result, the UE may avoid blind decoding for the second DCI, thereby reducing the processing effort (e.g., blind decoding) and power consumption for the UE.

According to another aspect of the present disclosure, a first DCI (e.g., a new format, an enhancement of a legacy format, or an extension of a legacy format) may be used to schedule a first set of resources for a first PDSCH. Additionally, the first DCI may indicate, or be indicative of, a second set of resources for a PUSCH (e.g., using a PUSCH resource indicator), or schedule the second set of resources for the PUSCH. Beneficially, upon decoding the first DCI, the UE may identify (e.g., become aware) that both DL and UL resources are scheduled (e.g., allocated to the UE), and thus the UE may avoid blind decoding, thereby reducing the processing effort (e.g., blind decoding) and power consumption for the UE.

According to another aspect of the present disclosure, a first DCI (e.g., a new format, an enhancement of a legacy format, or an extension of a legacy format) may be used to schedule a first PDSCH or a PUSCH, and to indicate one or more PDCCH candidates (e.g., by indicating a search space index), within which a second DCI for scheduling a second PUSCH or PDSCH may be received by the UE.

While presented as distinct solutions, one or more of the solutions described herein may be implemented in combination with each other. Additional aspects are disclosed that may be used in combination with any of the above described aspects (or a combination thereof), or may be implemented independent of the above described aspects. Aspects of the present disclosure are described in the context of a wireless communications system.

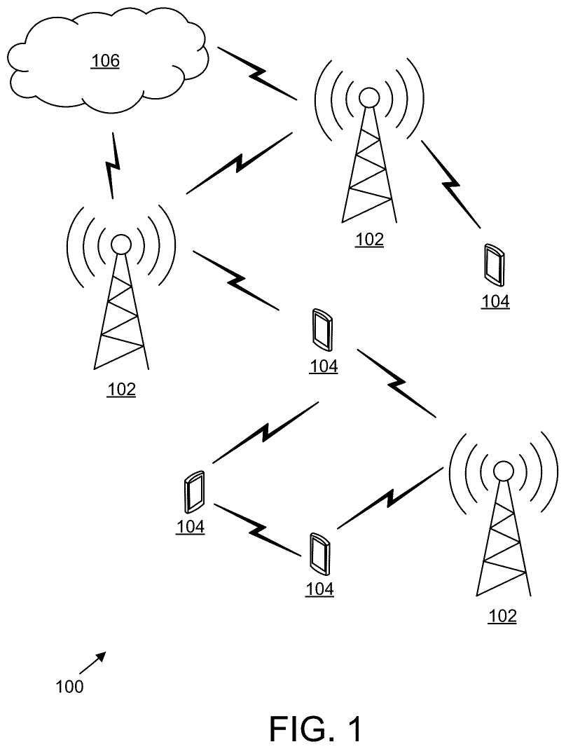

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies (RATs). In some implementations, the wireless communications system 100 may be a 4G network, such as a long-term evolution (LTE) network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a wireless communication network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) value and a cyclic prefix. A first numerology (e.g., μ=0) may be associated with a first SCS value (e.g., 15 kHz) and a normal cyclic prefix. In some implementations, the first numerology (e.g., μ=0) associated with the first SCS value (e.g., 15 kHz) may utilize one slot per subframe. A second numerology (e.g., μ=1) may be associated with a second SCS value (e.g., 30 kHz) and a normal cyclic prefix. A third numerology (e.g., μ=2) may be associated with a third SCS value (e.g., 60 kHz) and a normal cyclic prefix or an extended cyclic prefix. A fourth numerology (e.g., μ=3) may be associated with a fourth SCS value (e.g., 120 kHz) and a normal cyclic prefix. A fifth numerology (e.g., μ=4) may be associated with a fifth SCS value (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., p=0, p=1, μ=2, p=3, μ=4) associated with respective SCS values of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS value (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range #1 (FR1) (e.g., 410 MHZ-7.125 GHZ), frequency range #2 (FR2) (e.g., 24.25 GHz-52.6 GHz), frequency range #3 (FR3) (e.g., 7.125 GHZ-24.25 GHZ), frequency range #4 (FR4) (e.g., 52.6 GHZ-114.25 GHZ), frequency range #4a (FR4a) or frequency range #4-1 (FR4-1) (e.g., 52.6 GHz-71 GHZ), and frequency range #5 (FR5) (e.g., 114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 KHz SCS.

According to implementations, one or more of the NEs 102 and the UEs 104 may be operable to implement various aspects of the techniques described with reference to the present disclosure.

In the wireless communication system 100, a UE 104 may receive, from an NE 102, a first DCI that indicates a first resource allocation of a first set of resources for reception of a PDSCH. Additionally, the first DCI may be further indicative of a second resource allocation of a second set of resources for transmission of at least one or multiple PUSCH. In some examples, the NE 102 may transmit, and the UE 104 may receive, the PDSCH, where the PDSCH includes (e.g., carries) a second DCI. In such examples, the second DCI indicates the second resource allocation of the second set of resources for transmission of at least one or multiple PUSCH. The UE 104 may transmit the at least one or multiple PUSCH using the second set of resources.

In some examples, the transmission of the at least one or multiple PUSCH may be offset from the reception of the PDSCH by a number of symbols. The first DCI or the PDSCH may indicate the number of symbols.

In some examples, the UE 104 may identify (e.g., based on a PUSCH resource indicator) a PUSCH resource index mapping to the second set of resources, where the second set of resources is associated with a set of previously activated PUSCH resources (e.g., activated from a set of configured PUSCH resources).

In some examples, the NE 102 may transmit, to the UE 104, a configuration that includes (e.g., identifies) a first subset of parameters associated with the second set of resources. In such a case, the first DCI or the PDSCH includes a second subset of parameters associated with the second set of resources, such that the first subset and second subset form the complete set of parameters.

In some examples, the capability of the UE 104 includes support for full-duplex communications, where the reception of the PDSCH and transmission of a respective PUSCH of the at least one or multiple PUSCH is based at least in part on the capability of the UE 104 including support for full-duplex communications.

In the wireless communication system 100, one or more of NE 102 and UE 104 may support various DCI formats for scheduling PUSCH and may include a format for scheduling resources for PUSCH in one cell, a format for scheduling multiple PUSCH in a cell, or a format for scheduling multiple PUSCHs in multiple cells with one PUSCH per cell. Similarly, one or more of NE 102 and UE 104 may support various DCI formats for scheduling resources for PDSCH may include a format for scheduling PDSCH in one cell, a format for scheduling multiple PDSCH in one cell, or a format for scheduling multiple PUSCHs in multiple cells with one PUSCH per cell. Additionally, various DCI formats may be defined for other purposes including preemption, paging early indication (PEI), transmission power control (TPC), the scheduling of resources for sidelink (SL) resources in a cell, and the scheduling of resources for multicast and broadcast services (MBS).

The NE 102 may configure a UE 104 with one or more control resource sets (CORESETs) in which to search for DCI. The NE 102 may transmit the DCI in a PDCCH. DCI can be relatively large (e.g., spanning multiple control channel elements (CCEs)) and may be transmitted frequently. A CORESET defines a set of physical resource blocks (PRBs) and OFDM symbols within which the PDCCH, and therefore the DCI, can be transmitted and received.

In some cases, the UE 104 may be configured by the NE 102 with the information element (IE) ControlResourceSet via radio resource control (RRC) signaling, for example, in a RRC Reconfiguration message. Additionally, the UE 104 may be configured by the NE 102 with the IE SearchSpace, which specifies where to search for PDCCH transmissions carrying DCI. A search space is a set of CCEs and associated monitoring occasions within a CORESET where the UE 104 monitors for PDCCH transmissions carrying DCI. Each search space is associated with one ControlResource Set IE. Whereas the CORESET defines the time-frequency resources (i.e., resource grid region) where the NE 102 may transmit PDCCH, the SearchSpace IE defines when and how the UE 104 performs monitoring within a CORESET, for example, by specifying a schedule and associated rules for monitoring the time-frequency resources. In some examples, the SearchSpace IE indicates whether a particular search space is a common search space (CSS) (i.e., shared by multiple UEs), or a UE-specific search space (USS).

In the case of cross carrier scheduling, when a secondary cell (SCell) is scheduled, all optional fields in the search space configuration, except for the parameter nrofCandidates, are absent, regardless of their defined presence conditions. Similarly, for a scheduled special cell (SpCell) (i.e., referring to a primary cell (PCell) or primary SCell (PSCell)), if the search space is linked to (e.g., associated with) another search space for the scheduling SCell, all optional fields in the search space configuration, except for nrofCandidates, are absent, irrespective of their defined presence conditions.

In some wireless communication systems, such as 4G and 5G systems, separate DCI are required to schedule resources for PUSCH and PDSCH. Moreover, under the blind decoding approach, a UE 104 has to separately monitor the PDCCH for DCI related to scheduling resources for the PUSCH and for DCI related to scheduling resources for the PDSCH. To reduce the complexity associated with monitoring and decoding of DCI, the NE 102 may transmit a single DCI that schedules resources for both DL and UL for a UE 104.

A UE 104 may be configured to monitor and decode a DCI (e.g., a new DCI format or an enhanced DCI format) on one or more configured (and/or indicated) search spaces associated with a CORESET, where the DCI schedules resources for reception of one or more DL channels (or signals), or resources for transmission of one or more UL channels (or signals), or a combination thereof. In some examples, a CRC of the DCI may be scrambled by a specific RNTI, for example, associated with the transmission of UL signals or the reception of DL signals. For example, a C-RNTI may be used to scramble the CRC of the DCI for multiple channel scheduling.

In some other examples, the NE 102 may use a first DCI to schedule a PDSCH/PUSCH and to indicate one or more PDCCH candidates (e.g., by indicating a search space index), where a second DCI (e.g., transmitted in PDCCH) for scheduling a PUSCH/PDSCH may be located.

According to one aspect of the present disclosure, the network (e.g., NE 102) may use a first DCI (e.g., a new format, an enhancement of a legacy format, or an extension of a legacy format) to schedule a first set of resources for a first PDSCH. Additionally, the first DCI may indicate, or be indicative of, the presence of additional scheduling information (e.g., an UL DCI format) embedded within the first PDSCH. The additional scheduling information may be used to schedule a second set of resources, such as for one or multiple PUSCH, or for at least one second PDSCH. In certain embodiments, the first DCI may also schedule at least one PUSCH.

In some implementations, the additional scheduling information may be fully embedded within the first PDSCH. Alternatively, the additional scheduling information may be partially embedded within the first PDSCH. The first DCI may indicate if such embedded scheduling information exists, or not, in the first PDSCH.

In some examples, a UE 104 may be configured to monitor and decode the first DCI, where the first DCI (e.g., a first stage scheduling information) allocates (e.g., schedules) the first set of resources, i.e., for at least a first PDSCH. Moreover, the first DCI may include an indicator indicating that the corresponding (i.e., scheduled) first PDSCH is carrying second (e.g., additional) scheduling information (e.g., second stage) for allocating (e.g., scheduling) a second set of resources for a second channel, e.g., a PUSCH or a second PDSCH.

In another implementation, the selected DCI format itself provides an implicit indication to the UE 104 about the presence of the second scheduling information, i.e., to transmit the PUSCH or receive the second PDSCH. In an alternate implementation, a field in the first scheduling information (e.g., first DCI) or the second scheduling information (e.g., second DCI) may indicate whether the content of the second scheduling information is for scheduling first PUSCH or second PDSCH.

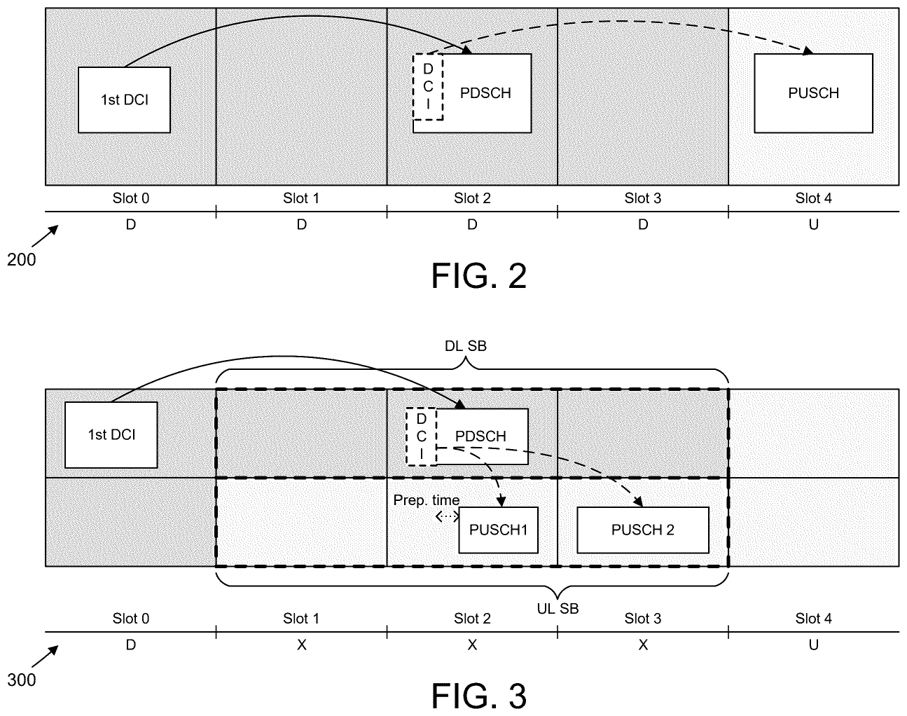

FIG. 2 illustrates an example of a TDD communication scheme 200 for transmission of a first DCI that indicates a second DCI is present in a PDSCH, in accordance with aspects of the present disclosure. The TDD communication scheme 200 may implement or be implemented by aspects of the wireless communication system 100. For example, the TDD communication scheme 200 may be performed by an NE and a UE, which may be an example of the NE 102 and the UE 104, as described herein.

The NE 102 and the UE 104 may support TDD, in which downlink communication and uplink communication occur during different time resources (e.g., slots) but share a same frequency resource (e.g., frequency band). In the example of FIG. 2, the NE 102 and the UE 104 may support wireless communication across one or more slots. Each slot may be configured (e.g., allocated, assigned) for either DL communication or UL communication. For example, slot 0 (D), slot 1 (D), slot 2 (D), and slot 3 (D) may be configured for DL communication, while slot 4 (U) may be configured for UL communication.

The NE 102 may transmit, and the UE 104 may receive, a first DCI during the first slot (i.e., slot 0). The first DCI may schedule (e.g., a first resource allocation of a first set of resources for reception of) a first PDSCH for a second slot (i.e., in slot 2). Put another way, the first DCI, transmitted/received during slot 0, may schedule the first PDSCH occurring in slot 2. Additionally, the first DCI may indicate, or be indicative of, that the scheduled first PDSCH may carry a second DCI that schedules (e.g., a second resource allocation of a second set of resources for transmission of) at least one PUSCH for a fifth slot (i.e., slot 4). Additionally, or alternatively, the second DCI may schedule at least one second PDSCH. In other examples, the first DCI or the second DCI may schedule sidelink resources, such as for a physical sidelink shared channel (PSSCH).

In the example of FIG. 2, the first DCI may be an enhanced DCI format 1_0, an enhanced DCI format 1_1, an enhanced DCI format 1_2, and/or an enhanced DCI format 1_3. In some cases, the UE 104 may expect, for example, that a scheduled PDSCH and a scheduled PUSCH do not share same time resources, or may determine the scheduled PDSCH and the scheduled PUSCH are invalid if they overlap (e.g., fully overlap or partially overlap) in the time domain. For example, the UE 104 may be incapable of full-duplex operation and/or may be operating in a half-duplex mode.

Additionally, one or more bits of the first DCI or a transport block (TB) associated with the first DCI may indicate to the UE 104 that the first PDSCH is carrying scheduling information (e.g., resource allocation) for the at least one PUSCH or the at least one second PDSCH. In some examples, the X most significant bits (MSBs) of the first DCI or the TB associated with the first DCI may indicate to the UE 104 that the first PDSCH is carrying scheduling information (e.g., resource allocation) for the at least one PUSCH or the at least one second PDSCH. In some other example, the X least significant bits (LSBs) of the first DCI or the TB associated with the first DCI may indicate to the UE 104 that the first PDSCH is carrying scheduling information (e.g., resource allocation) for the at least one PUSCH or the at least one second PDSCH.

In some examples, the NE 102 may indicate a value of X within the first DCI, or within the first PDSCH. In some other examples, the UE 104 may be preconfigured with the value of X.

FIG. 3 illustrates an example of a SBFD communication scheme 300 for transmission of a first DCI that indicates a second DCI is present in a PDSCH, in accordance with aspects of the present disclosure. The SBFD communication scheme 300 may implement or be implemented by aspects of the wireless communication system 100. For example, the SBFD communication scheme 300 may be performed by an NE and a UE, which may be an example of the NE 102 and the UE 104, as described herein.

The NE 102 and the UE 104 may support SBFD, in which downlink communication and uplink communication may occur during a same time resource (e.g., slot) but a different frequency resource (e.g., frequency band). In the example of FIG. 3, the NE 102 and the UE 104 may support wireless communication across one or multiple slots. Each slot may be configured (e.g., allocated, assigned) for either downlink communication, uplink communication, or both DL and UL communications. For example, slot 0 (D) may be configured for DL communication, while slot 4 (U) may be configured for UL communication, and slot 1 (X), slot 2 (X), and slot 3 (X) may be configured for DL and UL communications.

In some examples, the UE 104 may be a full-duplex capable UE. That is, the UE 104 may be capable of transmitting and receiving wireless communication (e.g., uplink transmissions, downlink reception) simultaneously. For example, the slot 1 (X), the slot 2 (X), and the slot 3 (X) may be configured (e.g., allocated, assigned) for simultaneous transmission and reception of wireless communication for the UE 104. An upper portion of the frequency resources associated with the slots 1 (X), the slot 2 (X), and the slot 3 (X) may form a downlink subband (DL SB), while a lower portion of the frequency resources associated with the slot 1 (X), the slot 2 (X), and the slot 3 (X) may form an uplink subband (UL SB).

The NE 102 may transmit, and the UE 104 may receive, a first DCI during a first slot (i.e., slot 0). The first DCI may schedule (e.g., a first resource allocation of a first set of resources for reception of) a first PDSCH for a second slot (e.g., in slot 2). In other words, the first DCI (i.e., transmitted/received during slot 0) may schedule the first PDSCH occurring in slot 2. Additionally, the first DCI may indicate, or be indicative of, that the scheduled first PDSCH may carry a second DCI that schedules (e.g., a second resource allocation of a second set of resources for transmission of) at least one first PUSCH for a third slot (e.g., in slot 2) and at least one second PUSCH for a fourth slot (e.g., in slot 3). Additionally, or alternatively, the second DCI may schedule (e.g., a third resource allocation of a third set of resources for reception of) at least one second PDSCH. In other examples, the first DCI or the second DCI may schedule sidelink resources, such as for a PSSCH.

In some cases, the UE 104 may expect, for example, that a scheduled PDSCH and a scheduled PUSCH may share same time resources, or may determine the scheduled PDSCH and the scheduled PUSCH are valid if they overlap (e.g., fully overlap or partially overlap) in the time domain.

In some implementations, the first scheduled PDSCH and the scheduled first PUSCH (or alternatively, the scheduled second PDSCH) may be transmitted in the same slot as the second DCI, or the scheduled first PUSCH (or alternatively, the scheduled second PDSCH) may be transmitted after an offset of at least S′ slots/symbols from the first scheduled PDSCH, where the value of S may be indicated in the first PDSCH and/or in the second DCI. In some examples, the offset (e.g., of at least S slots/symbols) from the second DCI (or from the first PDSCH) may account for a preparation time required for the first PUSCH (i.e., PUSCH transmission). For example, the preparation time may correspond to the last symbol of the second DCI associated with the second PUSCH. In some implementations, one or more resources (e.g., corresponding to the PUSCH or the second PDSCH) may be indicated relative to the resources of the first PDSCH, such as through an offset in time and/or of frequency resources.

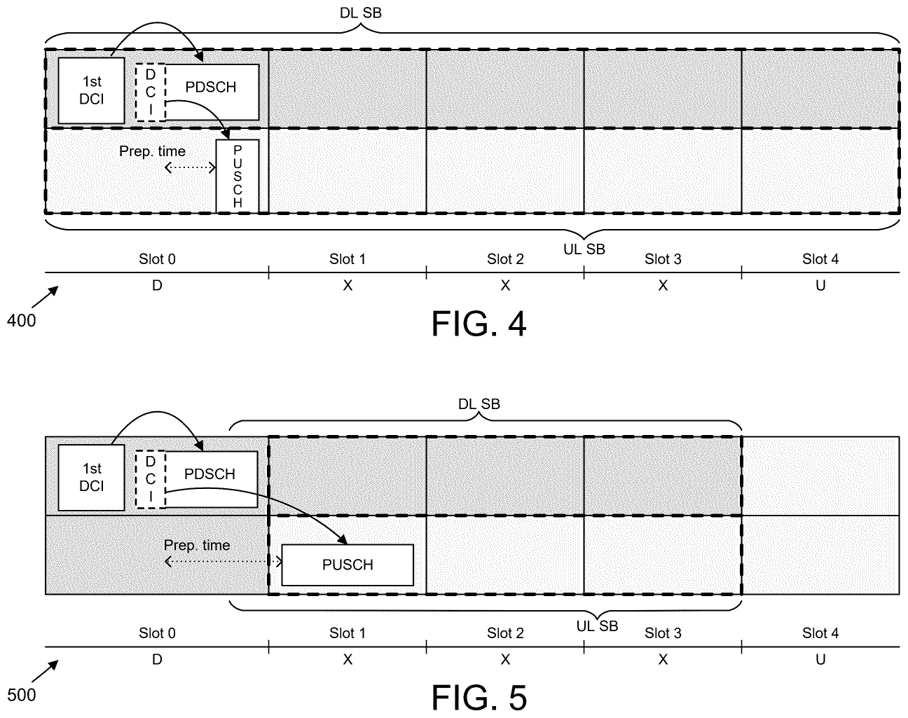

FIG. 4 illustrates an example of a SBFD communication scheme 400 for transmission of a first DCI that indicates a second DCI is present in a PDSCH, in accordance with aspects of the present disclosure. The SBFD communication scheme 400 may implement or be implemented by aspects of the wireless communication system 100. For example, the SBFD communication scheme 400 may be performed by an NE and a UE, which may be an example of the NE 102 and the UE 104, as described herein.

The NE 102 and the UE 104 may support SBFD, in which downlink communication and uplink communication may occur during a same time resource (e.g., slot) but a different frequency resource (e.g., frequency band). In the example of FIG. 3, the NE 102 and the UE 104 may support wireless communication across one or multiple slots. Each slot may be configured (e.g., allocated, assigned) for either downlink communication, uplink communication, or both DL and UL communications. For example, slot 0 (X), slot 1 (X), slot 2 (X), slot 3 (X), and slot 4 (X) may be configured for DL and UL communications.

In some examples, the UE 104 may be a full-duplex capable UE. That is, the UE 104 may be capable of transmitting and receiving wireless communication (e.g., uplink transmissions, downlink reception) simultaneously. For example, the slot 0 (X), slot 1 (X), slot 2 (X), slot 3 (X), and slot 4 (X) may be configured (e.g., allocated, assigned) for simultaneous transmission and reception of wireless communication for the UE 104. An upper portion of the frequency resources associated with the slot 0 (X), slot 1 (X), slot 2 (X), slot 3 (X), and slot 4 (X) may form a DL SB, while a lower portion of the frequency resources associated with the slot 0 (X), slot 1 (X), slot 2 (X), slot 3 (X), and slot 4 (X) may form an UL SB.

The NE 102 may transmit, and the UE 104 may receive, a first DCI during a first slot (e.g., slot 0). The first DCI may schedule (e.g., a first resource allocation of a first set of resources for reception of) a first PDSCH for a second slot (e.g., in slot 0). In other words, the first DCI (e.g., transmitted/received during slot 0) may schedule the first PDSCH occurring in slot 0. Additionally, the first DCI may indicate, or be indicative of, that the scheduled first PDSCH may carry a second DCI that schedules (e.g., a second resource allocation of a second set of resources for transmission of) at least one first PUSCH for a third slot (e.g., in slot 0). In other examples, the first DCI or the second DCI may schedule sidelink resources, such as for a PSSCH.

In some cases, the UE 104 may expect, for example, that a scheduled PDSCH and a scheduled PUSCH may share same time resources, or may determine the scheduled PDSCH and the scheduled PUSCH are valid if they overlap (e.g., fully overlap or partially overlap) in the time domain. In some implementations, the first scheduled PDSCH and the scheduled first PUSCH may be transmitted in the same slot as the second DCI, or the first scheduled PDSCH and the scheduled first PUSCH (or alternatively, the scheduled second PDSCH) may be transmitted after an offset of at least S slots/symbols from the first scheduled PDSCH, where the value of S may be indicated in the first PDSCH and/or in the second DCI.

In some examples, the offset (e.g., of at least S slots/symbols) from the second DCI (or from the first PDSCH) may account for a preparation time required for the first PUSCH (i.e., PUSCH transmission). For example, the preparation time may correspond to the last symbol of the second DCI associated with the PUSCH or the second PDSCH. In some implementations, one or more resources (e.g., corresponding to the PUSCH or the second PDSCH) may be indicated relative to the resources of the first PDSCH, such as through an offset in time and/or of frequency resources.

FIG. 5 illustrates an example of a SBFD communication scheme 500 for transmission of a first DCI that indicates a second DCI is present in a PDSCH, in accordance with aspects of the present disclosure. The SBFD communication scheme 500 may implement or be implemented by aspects of the wireless communication system 100. For example, the SBFD communication scheme 500 may be performed by an NE and a UE, which may be an example of the NE 102 and the UE 104, as described herein.

The NE 102 and the UE 104 may support SBFD, in which downlink communication and uplink communication may occur during a same time resource (e.g., slot) but a different frequency resource (e.g., frequency band). In the example of FIG. 3, the NE 102 and the UE 104 may support wireless communication across one or multiple slots. Each slot may be configured (e.g., allocated, assigned) for either downlink communication, uplink communication, or both DL and UL communications. For example, slot 0 (D) may be configured for DL communication, while slot 4 (U) may be configured for UL communication, and slot 1 (X), slot 2 (X), and slot 3 (X) may be configured for DL and UL communications.

In some examples, the UE 104 may be a full-duplex capable UE. That is, the UE 104 may be capable of transmitting and receiving wireless communication (e.g., uplink transmissions, downlink reception) simultaneously. For example, the slot 1 (X), the slot 2 (X), and the slot 3 (X) may be configured (e.g., allocated, assigned) for simultaneous transmission and reception of wireless communication for the UE 104. An upper portion of the frequency resources associated with the slots 1 (X), the slot 2 (X), and the slot 3 (X) may form a DL SB, while a lower portion of the frequency resources associated with the slot 1 (X), the slot 2 (X), and the slot 3 (X) may form an UL SB.

The NE 102 may transmit, and the UE 104 may receive, a first DCI during a first slot (e.g., slot 0). The first DCI may schedule (e.g., a first resource allocation of a first set of resources for reception of) a first PDSCH for a second slot (e.g., in slot 0). In other words, the first DCI (e.g., transmitted/received during slot 0) indicate, or be indicative of, that the scheduled first PDSCH may carry a second DCI that schedules (e.g., a second resource allocation of a second set of resources for transmission of) at least one first PUSCH for a third slot (e.g., in slot 1). Additionally, or alternatively, the second DCI may schedule (e.g., third resource allocation of a third set of resources for reception of) at least one second PDSCH. In other examples, the first DCI or the second DCI may schedule sidelink resources, such as for a PSSCH.

In some embodiments, if the UE 104 is configured to monitor (e.g., detect and/or decode) the second DCI, or if it detects and decodes the second DCI, the UE 104 may be configured explicitly (e.g., via the DCI message) or implicitly (e.g., via predefined rules/conditions) to stop monitoring one or more of other DCIs for scheduling PDSCH or PUSCH, e.g., for a number of slots or a period of time. In some other examples, the UE 104 may be preconfigured with the number of slots or the period of time.

In some implementations, the additional scheduling information may be fully embedded within the first PDSCH. Alternatively, the additional scheduling information may be partially embedded within the first PDSCH. The first DCI may indicate if such embedded scheduling information exists, or not, in the first PDSCH. In some examples, the second DCI may be embedded within the PDSCH resources by rate matching around the first PDSCH resources. Here, the number of coded bits of the second DCI may be mapped after rate matching the first PDSCH resource. The rate matching pattern may be already indicated to the UE 104. In another example, the second DCI can be embedded within the first PDSCH resources where the first few resources can be reserved for the DCI coded bits. In some examples, the modulation and coding scheme (MCS) of the second DCI second may be differently configured (e.g., semi-statically configured) as compared to the MCS of the first PDSCH resource.

According to other aspects of the present disclosure, the network (e.g., NE 102) may use a DCI to schedule a first set of resources for a first channel (e.g., PDSCH, alternatively PUSCH), and to indicate a second set of resources for a second channel (e.g., PUSCH, alternatively PDSCH), such as by providing a resource indicator. For example, to indicate a PUSCH resource, the network (e.g., NE 102) may provide a PUSCH resource indicator in the DCI. As another example, to indicate a PDSCH resource, the network (e.g., NE 102) may provide a PDSCH resource indicator within the DCI. In some implementations, the second set of resources for the second channel (e.g., PUSCH or PDSCH) may be predefined by a higher layer signaling (e.g., RRC configuration message), such that the DCI indicates a specific resource (or set of resources) from a predefined group of resources.

In some implementations, the DCI may include a PUSCH resource indicator parameter that points to (or activates) a specific PUSCH resource index in a configured (e.g., predefined) PUSCH resource set. The bitfield size of PUSCH resource indicator parameter may be determined based on the number of configured/defined PUSCH resources.

Similarly, in other implementations, the DCI may include a PDSCH resource indicator parameter that points to (or activates) a specific PDSCH resource index in a configured (e.g., predefined) PDSCH resource set. The bitfield size of PDSCH resource indicator parameter may be determined based on the number of configured/defined PDSCH resources.

In yet other embodiments, the DCI may include a PSSCH resource indicator parameter that points to (or activates) a specific PSSCH resource index in a configured (e.g., predefined) PSSCH resource set. The bitfield size of PSSCH resource indicator parameter may be determined based on the number of configured/defined PSSCH resources.

In some implementations, all transmission resource parameters of the second set of resources for a second channel may be configured (e.g., predefined) by higher layer signaling (e.g., by RRC signaling and/or medium access control-control element (MAC-CE) signaling). Here, the transmission resource parameters include, but are not limited to, time resources, frequency resources, periodicity, MCS index, number of repetitions, repetition type, transmission configuration indicator (TCI)-state(s), etc. In some examples, the network (e.g., NE 102) may use RRC signaling may configure a first number, N, of second set of resources for the second channel (e.g., a number of PUSCH resource sets N), and may use MAC-CE signaling may activate a second number, M, of second set of resources for the second channel (e.g., a PUSCH resource set that has M PUSCH resources), e.g., where M ≤ N, such that the resource indicator identifies a specific resource (or set of resources) for the second channel. For example, the value of a signaled parameter “PUSCH resource index” may indicate a PUSCH resource among the M PUSCH resources activated by the MAC-CE signaling.

In other implementations, some transmission resource parameters of the PUSCH resource (i.e., a first subset of parameters) may be configured (e.g., predefined) by higher layer signaling (e.g., by RRC signaling and/or MAC-CE signaling), while other parameters (i.e., a remaining subset of parameters or second subset of parameters) may be dynamically indicated via the DCI. In some examples, the subset of parameters configured by RRC signaling (and/or MAC-CE signaling) included, e.g., periodicity, MCS index, number of repetitions, and repetition type (i.e., repetition type A/B) for each PUSCH resource, while the remaining subset of parameters configured by the DCI indicates, e.g., time resources, frequency resources, TCI-state(s), etc.

In yet other implementations, all the transmission resource parameters and all the receiption resource parameters for one or more PDSCH and PUSCH channel may be indicated by the DCI, i.e., using a unified UL-DL DCI format.

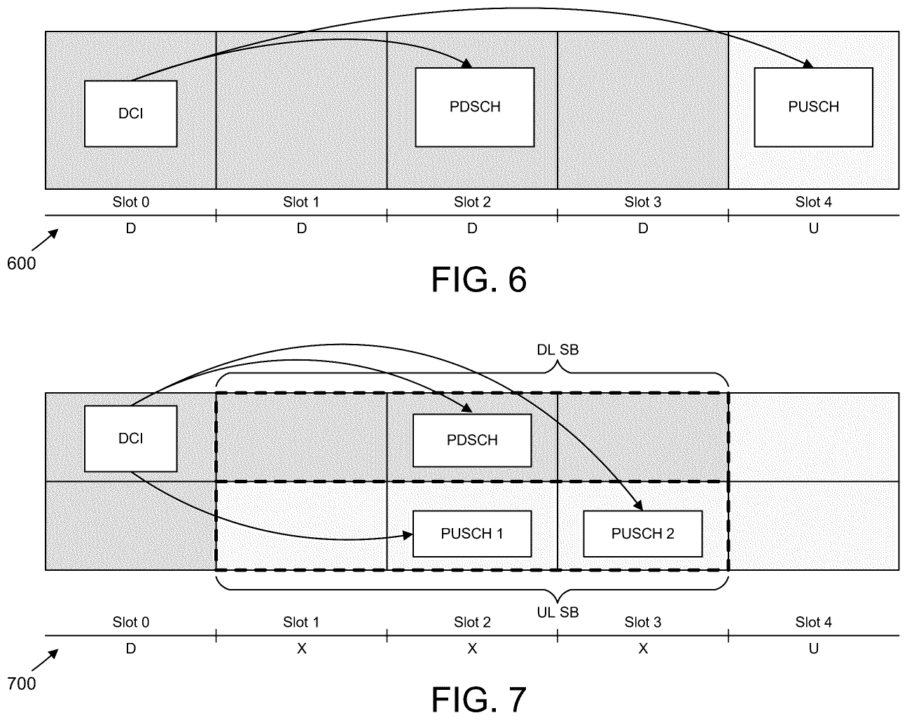

FIG. 6 illustrates an example of a TDD communication scheme 600 for transmission of a DCI that indicates or schedules communication resources on multiple channels, in accordance with aspects of the present disclosure. The TDD communication scheme 600 may implement or be implemented by aspects of the wireless communication system 100. For example, the TDD communication scheme 600 may be performed by an NE and a UE, which may be an example of the NE 102 and the UE 104, as described herein.

The NE 102 and the UE 104 may support TDD, in which downlink communication and uplink communication occur during different time resources (e.g., slots) but share a same frequency resource (e.g., frequency band). In the example of FIG. 2, the NE 102 and the UE 104 may support wireless communication across one or more slots. Each slot may be configured (e.g., allocated, assigned) for either DL communication or UL communication. For example, slot 0 (D), slot 1 (D), slot 2 (D), and slot 3 (D) may be configured for DL communication, while slot 4 (U) may be configured for UL communication.

The NE 102 may transmit, and the UE 104 may receive, a DCI during the first slot (i.e., slot 0). The DCI may schedule (e.g., a first resource allocation of a first set of resources for reception of) a first PDSCH for a second slot (i.e., slot 2). Put another way, the DCI, transmitted/received during slot 0, may schedule the first PDSCH occurring in slot 2. Additionally, the DCI may further indicate, or be indicative of, a second resource allocation of a second set of resources for transmission of a first PUSCH for a third slot (i.e., slot 4), e.g., using a PUSCH resource indicator. In some examples, the DCI may schedule the second resource allocation of the second set of resources for the first PUSCH. Additionally, or alternatively, the DCI may schedule second reception resources, e.g., for at least one second PDSCH. In the example of FIG. 6, the DCI may be an enhanced DCI format 1_0, an enhanced DCI format 1_1, an enhanced DCI format 1_2, and/or an enhanced DCI format 1_3).

In an alternate example, the DCI (e.g., transmitted/received during slot 0) may schedule (e.g., a first resource allocation of a first set of resources for transmission of) a first PUSCH and may further indicate, or be indicative of, a second resource allocation of a second set of resources for reception of a first PDSCH, e.g., using a PDSCH resource indicator. In some examples, the DCI may schedule the second resource allocation of the second set of resources for reception of the first PDSCH. Additionally, or alternatively, the DCI may schedule second transmission resources, e.g., for at least one second PUSCH. In other examples, the DCI may also indicate (or directly schedule) sidelink resources, e.g., for a PSSCH. In the alternate example, the DCI may be an enhanced DCI format 0_0, an enhanced DCI format 0_1, an enhanced DCI format 0_2, and/or an enhanced DCI format 0_3). FIG. 7 illustrates an example of a SBFD communication scheme 700 for transmission of a DCI that indicates or schedules communication resources on multiple channels, in accordance with aspects of the present disclosure. The SBFD communication scheme 700 may implement or be implemented by aspects of the wireless communication system 100. For example, the SBFD communication scheme 700 may be performed by an NE and a UE, which may be an example of the NE 102 and the UE 104, as described herein.

The NE 102 and the UE 104 may support SBFD, in which downlink communication and uplink communication may occur during a same time resource (e.g., slot) but a different frequency resource (e.g., frequency band). In the example of FIG. 3, the NE 102 and the UE 104 may support wireless communication across one or multiple slots. Each slot may be configured (e.g., allocated, assigned) for either downlink communication, uplink communication, or both DL and UL communications. For example, slot 0 (D) may be configured for DL communication, while slot 4 (U) may be configured for UL communication, and slot 1 (X), slot 2 (X), and slot 3 (X) may be configured for DL and UL communications.

In some examples, the UE 104 may be a full-duplex capable UE. That is, the UE 104 may be capable of transmitting and receiving wireless communication (e.g., uplink transmissions, downlink reception) simultaneously. For example, the slot 1 (X), the slot 2 (X), and the slot 3 (X) may be configured (e.g., allocated, assigned) for simultaneous transmission and reception of wireless communication for the UE 104. An upper portion of the frequency resources associated with the slots 1 (X), the slot 2 (X), and the slot 3 (X) may form a DL SB, while a lower portion of the frequency resources associated with the slot 1 (X), the slot 2 (X), and the slot 3 (X) may form an UL SB.

The NE 102 may transmit, and the UE 104 may receive, a DCI during a first slot (e.g., slot 0). The first DCI may schedule (e.g., a first resource allocation of a first set of resources for reception of) a first PDSCH for a second slot (e.g., in slot 2). Put another way, the DCI (i.e., transmitted/received during slot 0) may schedule the first PDSCH occurring in slot 2. Additionally, the DCI may indicate, or be indicative of, a second resource allocation of a second set of resources for transmission of a first PUSCH for a third slot (e.g., in slot 2) and a second PUSCH for a fourth slot (e.g., in slot 3). Alternatively, the DCI may schedule the first set of resources for reception of the first PDSCH and schedule the second set of resources for transmission of the first PUSCH and the second PUSCH. Additionally, or alternatively, the DCI may indicate (or schedule) a third resource allocation of a third set of resources for reception of at least one second PDSCH. In the example of FIG. 7, the DCI may be an enhanced DCI format 1_0, an enhanced DCI format 1_1, an enhanced DCI format 1_2, and/or an enhanced DCI format 1_3).

In an alternate example, the DCI (e.g., transmitted/received during slot 0) may schedule (e.g., a first resource allocation of a first set of resources for transmission of) a first PUSCH and may further indicate, or be indicative of, a second resource allocation of a second set of resources for reception of a first PDSCH, e.g., using a PDSCH resource indicator. In some examples, the DCI may schedule the second resource allocation of the second set of resources for reception of the PDSCH. Additionally, or alternatively, the DCI may schedule second transmission resources, e.g., for at least one second PUSCH. In other examples, the DCI may also indicate (or directly schedule) sidelink resources, e.g., for a PSSCH. In the alternate example, the DCI may be an enhanced DCI format 0_0, an enhanced DCI format 0_1, an enhanced DCI format 0_2, and/or an enhanced DCI format 0 3).

In some cases, the UE 104 may expect, for example, that a scheduled PDSCH and a scheduled PUSCH may share same time resources, or may determine the scheduled PDSCH and the scheduled PUSCH are valid if they overlap (e.g., fully overlap or partially overlap) in the time domain.

In some implementations, the scheduled first PDSCH may be transmitted in the same slot as the scheduled first PUSCH (or alternatively, the scheduled second PDSCH), or the scheduled first PUSCH (or alternatively, the scheduled second PDSCH) may be transmitted after an offset of at least S slots/symbols from the first scheduled PDSCH, where the value of S may be indicated in the first PDSCH and/or in the second DCI. In some examples, the offset (e.g., of at least S slots/symbols) from the second DCI (or from the first PDSCH) may account for a preparation time required for the first PUSCH (i.e., PUSCH transmission). In some implementations, one or more resources (e.g., corresponding to the first PUSCH or the second PUSCH) may be indicated relative to the resources of the first PDSCH, such as through an offset in time and/or of frequency resources.

According to yet other aspects of the present disclosure, the network (e.g., NE 102) may use a first DCI to schedule a first set of resources for a first channel (e.g., a PDSCH, alternatively a PUSCH or a PSSCH). Additionally, the first DCI may indicate, or be indicative of, a search space (e.g., indicating, or indicative of, one or more PDCCH candidates) within which a second DCI for scheduling second channel resources may be received by the UE 104.

As described above, the search space is mapping information that informs the UE 104 where (i.e., in frequency and time) to search for a PDCCH-and specifically for one or more DCI messages on the PDCCH, how often to search for the PDCCH (and a DCI), the aggregation level (i.e., number of CCEs used to carry the DCI), and for which DCI formats to search. Thus, the UE 104 may attempt to decode a DCI only within the CCEs and monitoring occasions defined in its configured search spaces. Beneficially, indicating the search space(s) for the second DCI narrows the search field and improves decoding efficiency of the UE 104.

In some embodiments, the first DCI may schedule (e.g., a first resource allocation of a first set of resources for reception of at least one PDSCH. Alternatively, the first DCI may schedule (e.g., a first resource allocation of a first set of resources for transmission of at least one PUSCH. Additionally, the first DCI may indicate, or be indicative of, one or more search space indices within which the UE 104 is expected to monitor one or more PDCCH candidates carrying a DCI that allocates transmission (or reception) resources to at least one PUSCH (or PDSCH), or jointly for at least one PUSCH and PDSCH.

Because the UE 104 is likely to be configured with different search spaces, it will need to monitor each of the configured search spaces to detect and decode a DCI. However, the first DCI may indicate a subset of the configured search spaces, thereby reducing the resources the UE 104 monitors and consequently reducing resource consumption and improving battery life. Alternatively, the network (e.g., NE 102) may adaptively increase, decrease, or otherwise modify the search spaces, e.g., based on radio conditions, network load, etc.

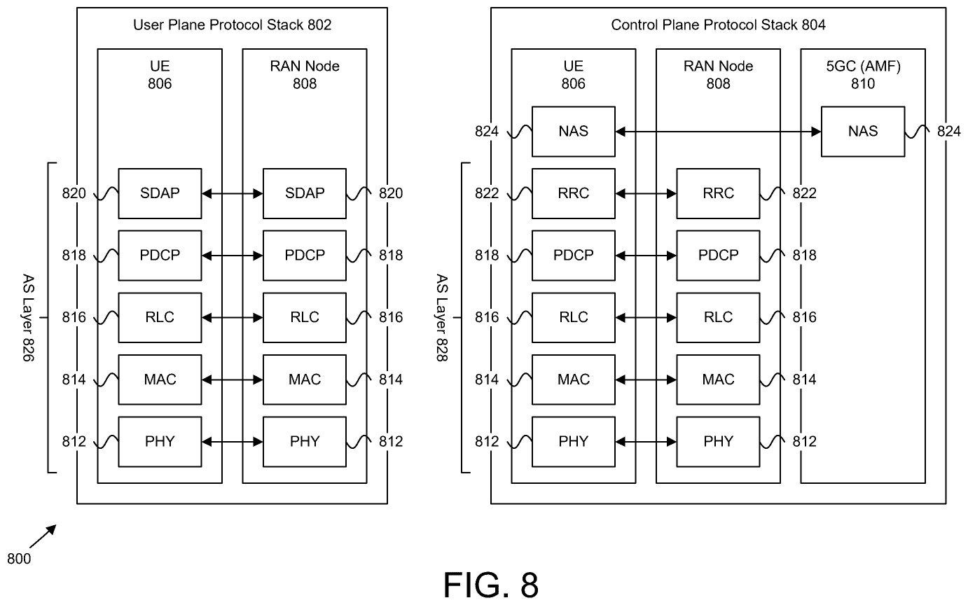

FIG. 8 illustrates an example of a protocol stack 800, in accordance with aspects of the present disclosure. While FIG. 8 shows a UE 806, a RAN node 808, and a 5GC 810 (e.g., comprising at least an AMF), these are representative of a set of UEs 104 interacting with an NE 102 (e.g., base station) and a CN 106. As depicted, the protocol stack 800 comprises a user plane protocol stack 802 and a control plane protocol stack 804. The user plane protocol stack 802 includes a physical (PHY) layer 812, a MAC sublayer 814, a radio link control (RLC) sublayer 816, a packet data convergence protocol (PDCP) sublayer 818, and a service data adaptation protocol (SDAP) sublayer 820. The control plane protocol stack 804 includes a PHY layer 812, a MAC sublayer 814, an RLC sublayer 816, and a PDCP sublayer 818. The Control Plane protocol stack 804 also includes an RRC layer 822 and a non-access stratum (NAS) layer 824.

The AS layer 826 (also referred to as “AS protocol stack”) for the user plane protocol stack 802 consists of at least the SDAP sublayer 820, the PDCP sublayer 818, the RLC sublayer 816, the MAC sublayer 814, and the PHY layer 812. The AS layer 828 for the control plane protocol stack 804 consists of at least the RRC layer 822, the PDCP sublayer 818, the RLC sublayer 816, the MAC sublayer 814, and the PHY layer 812. The layer-1 (L1) includes the PHY layer 812. The layer-2 (L2) is split into the SDAP sublayer 820, PDCP sublayer 818, RLC sublayer 816, and MAC sublayer 814. The layer-3 (L3) includes the RRC layer 822 and the NAS layer 824 for the control plane and includes, e.g., an internet protocol (IP) layer and/or PDU layer (not depicted) for the user plane. L1 and L2 are referred to as “lower layers,” while L3 and above (e.g., transport layer, application layer) are referred to as “higher layers” or “upper layers.”

The PHY layer 812 offers transport channels to the MAC sublayer 814. The PHY layer 812 may perform a beam failure detection procedure using energy detection thresholds, as described herein. In certain embodiments, the PHY layer 812 may send an indication of beam failure to a MAC entity at the MAC sublayer 814. The MAC sublayer 814 offers logical channels (LCHs) to the RLC sublayer 816. The RLC sublayer 816 offers RLC channels to the PDCP sublayer 818.

The PDCP sublayer 818 offers radio bearers to the SDAP sublayer 820 and/or RRC layer 822. The SDAP sublayer 820 offers QoS flows to the core network (e.g., 5GC). The RRC layer 822 provides for the addition, modification, and release of carrier aggregation (CA) and/or dual connectivity. The RRC layer 822 also manages the establishment, configuration, maintenance, and release of signaling radio bearers (SRBs) and data radio bearers (DRBs).

The NAS layer 824 is between the UE 806 and an AMF in the 5GC 810. NAS messages are passed transparently through the RAN. The NAS layer 824 is used to manage the establishment of communication sessions and for maintaining continuous communication with the UE 806 as it moves between different cells of the RAN. In contrast, the AS layers 826 and 828 are between the UE 806 and the RAN (i.e., RAN node 808) and carry information over the wireless portion of the network. While not depicted in FIG. 8, the IP layer exists above the NAS layer 824, a transport layer exists above the IP layer, and an application layer exists above the transport layer.

The MAC sublayer 814 is the lowest sublayer in the L2 architecture of the NR protocol stack. Its connection to the PHY layer 812 below is through transport channels, and the connection to the RLC sublayer 816 above is through LCHs. The MAC sublayer 814 therefore performs multiplexing and demultiplexing between LCHs and transport channels: the MAC sublayer 814 in the transmitting side constructs MAC PDUs (also known as transport blocks (TBs)) from MAC service data units (SDUs) received through LCHs, and the MAC sublayer 814 in the receiving side recovers MAC SDUs from MAC PDUs received through transport channels.

The MAC sublayer 814 provides a data transfer service for the RLC sublayer 816 through LCHs, which are either control LCHs which carry control data (e.g., RRC signaling) or traffic LCHs which carry user plane data. On the other hand, the data from the MAC sublayer 814 is exchanged with the PHY layer 812 through transport channels, which are classified as UL or DL. Data is multiplexed into transport channels depending on how it is transmitted over the air.

The PHY layer 812 is responsible for the actual transmission of data and control information via the air interface, i.e., the PHY layer 812 carries all information from the MAC transport channels over the air interface on the transmission side. Some of the important functions performed by the PHY layer 812 include coding and modulation, link adaptation (e.g., adaptive modulation and coding (AMC)), power control, cell search and random access (for initial synchronization and handover purposes) and other measurements (inside the 3rd generation partnership project (3GPP) system (i.e., NR and/or LTE system) and between systems) for the RRC layer 822. The PHY layer 812 performs transmissions based on transmission parameters, such as the modulation scheme, the coding rate (i.e., the MCS), the number of physical resource blocks (PRBs), etc.

In some embodiments, the protocol stack 800 may be an NR protocol stack used in a 5G NR system. Note that an LTE protocol stack comprises similar structure to the protocol stack 800, with the differences that the LTE protocol stack lacks the SDAP sublayer 820 in the AS layer 826, that an EPC replaces the 5GC 810, and that the NAS layer 824 is between the UE 806 and an MME in the EPC. Also note that the present disclosure distinguishes between a protocol layer (such as the aforementioned PHY layer 812, MAC sublayer 814, RLC sublayer 816, PDCP sublayer 818, SDAP sublayer 820, RRC layer 822 and NAS layer 824) and a transmission layer in multiple-input multiple-output (MIMO) communication (also referred to as a “MIMO layer” or a “data stream”).

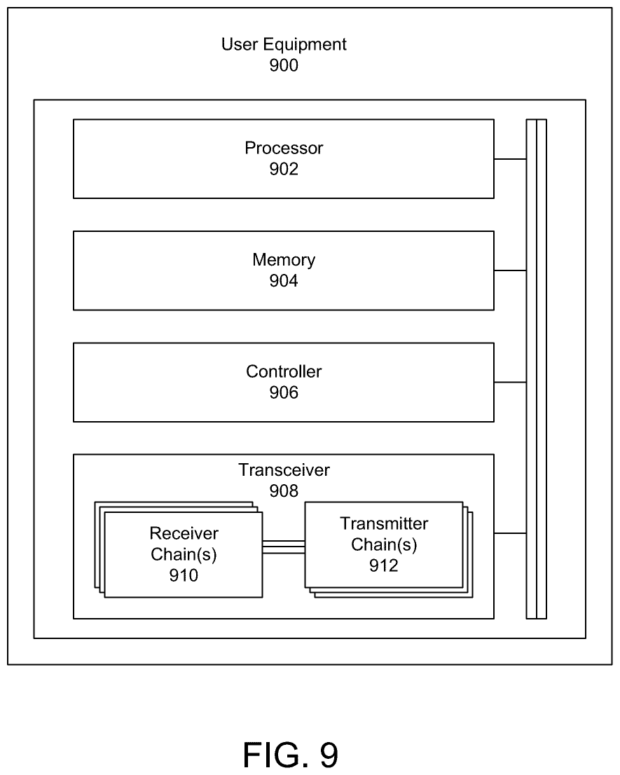

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a central processing unit (CPU), an ASIC, a field programmable gate array (FPGA), or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions that, when executed by the processor 902, cause the UE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform various functions (e.g., operations, signaling) described herein (e.g., executing, by the processor 902, instructions stored in the memory 904). In some implementations, the processor 902 may include multiple processors and the memory 904 may include multiple memories. One or more of the multiple processors may be coupled with one or more of the multiple memories, which may be individually or collectively, configured to perform various functions (e.g., operations, signaling) of the UE 900 as described herein.

The processor 902 coupled with the memory 904 may be configured to, capable of, or operable to cause the UE 900 to receive a first DCI; and transmit the at least one or multiple PUSCH using the second set of resources. In such implementations, the first DCI indicates a first resource allocation of a first set of resources for reception of a PDSCH, and the first DCI further is indicative of a second resource allocation of a second set of resources for transmission of at least one or multiple PUSCH.

In some implementations, the processor 902 coupled with the memory 904 may be configured to cause the UE 900 to receive the PDSCH, where the received PDSCH includes a second DCI. In such implementations, the second DCI indicates the second resource allocation of the second set of resources for transmission of at least one or multiple PUSCH. In certain implementations, the second resource allocation of the second set of resources includes an allocation of downlink resources for at least one second PDSCH.

In some implementations, the first DCI further indicates one or more search spaces associated with a second DCI located in a PDCCH. In such implementations, the second DCI indicates the second resource allocation of the second set of resources for transmission of the at least one or multiple PUSCH or reception of at least one second PDSCH.

In some implementations, a set of MSBs of a transport block (TB) of the PDSCH indicates the second resource allocation of the second set resources for transmission of the at least one or multiple PUSCH. In other implementations, a set of LSBs of a TB of the PDSCH indicates the second resource allocation of the second set resources for transmission of the at least one or multiple PUSCH.

In some implementations, the transmission of the at least one or multiple PUSCH is offset from the reception of the PDSCH by a number of symbols, where the first DCI or the PDSCH further indicates the number of symbols.

In some implementations, the processor 902 coupled with the memory 904 may be configured to cause the UE 900 to identify (e.g., based on a PUSCH resource indicator) a PUSCH resource index mapping to the second set of resources, where the second set of resources is associated with a set of previously activated PUSCH resources. For example, the UE 900 may receive MAC-CE signaling that activates specific PUSCH resources from a configured (e.g., predefined) PUSCH resource set.

In some implementations, the processor 902 coupled with the memory 904 may be configured to cause the UE 900 to receive a configuration that includes a first subset of parameters associated with the second set of resources, where the first DCI or the PDSCH includes a second subset of parameters associated with the second set of resources.

In some implementations, the capability of the UE includes support for full-duplex communications, where the reception of the PDSCH and transmission of a respective PUSCH of the at least one or multiple PUSCH is based at least in part on the capability of the UE include support for full-duplex communications.

The controller 906 may manage input and output signals for the UE 900. The controller 906 may also manage peripherals not integrated into the UE 900. In some implementations, the controller 906 may utilize an operating system (OS) such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding/processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

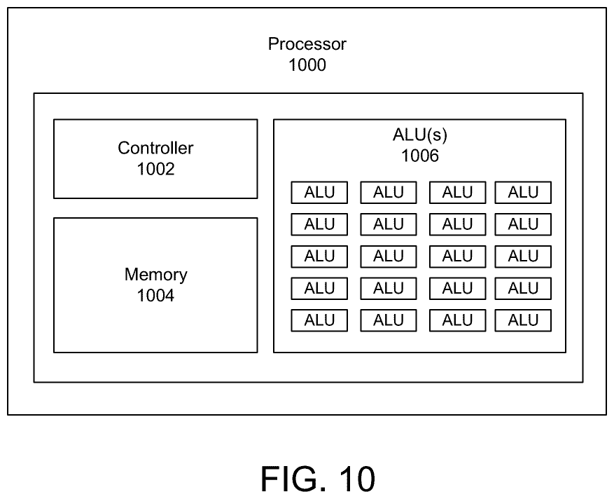

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1, or L2, or L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, arithmetic logic units (ALUs), and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

In some implementations, the processor 1000 may support various functions (e.g., operations, signaling) of a UE, in accordance with examples as disclosed herein. For example, the controller 1002 coupled with the memory 1004 may be configured to, capable of, or operable to cause the processor 1000 to receive a first DCI, wherein the first DCI indicates a first resource allocation of a first set of resources for reception of a PDSCH, and wherein the first DCI further is indicative of a second resource allocation of a second set of resources for transmission of at least one or multiple PUSCH; and transmit the at least one or multiple PUSCH using the second set of resources. Additionally, the controller 1002 coupled with the memory 1004 may be configured to, capable of, or operable to cause the processor 1000 to perform one or more functions (e.g., operations, signaling) of the UE as described herein.

Additionally, or alternatively, in some other implementations, the processor 1000 may support various functions (e.g., operations, signaling) of a base station, in accordance with examples as disclosed herein. For example, the controller 1002 coupled with the memory 1004 may be configured to, capable of, or operable to cause the processor 1000 to transmit a first DCI to a UE, wherein the first DCI indicates a first resource allocation of a first set of resources for transmission of a PDSCH, and wherein the first DCI further is indicative of a second resource allocation of a second set of resources for at least one or multiple PUSCH; and receive the at least one or multiple PUSCH using the second set of resources. Additionally, the controller 1002 coupled with the memory 1004 may be configured to, capable of, or operable to cause the processor 1000 to perform one or more functions (e.g., operations, signaling) of the base station as described herein.

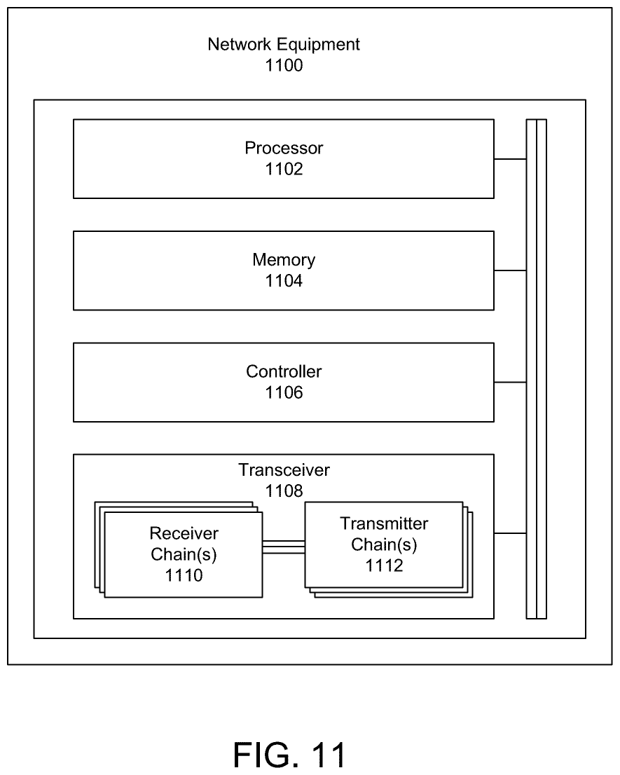

FIG. 11 illustrates an example of a NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform various functions (e.g., operations, signaling) described herein (e.g., executing, by the processor 1102, instructions stored in the memory 1104). In some implementations, the processor 1102 may include multiple processors and the memory 1104 may include multiple memories. One or more of the multiple processors may be coupled with one or more of the multiple memories, which may be individually or collectively, configured to perform various functions (e.g., operations, signaling) of the NE 1100 as described herein.

For example, the processor 1102 coupled with the memory 1104 may be configured to, capable of, or operable to cause the NE 1100 to transmit a first DCI to a UE; and receive at least one or multiple PUSCH using the second set of resources. In such implementations, the first DCI indicates a first resource allocation of a first set of resources for transmission of a PDSCH, and the first DCI further is indicative of a second resource allocation of a second set of resources for at least one or multiple PUSCH.

In some implementations, the processor 1102 coupled with the memory 1104 may be configured to cause the NE 1100 to transmit the PDSCH, where the transmitted PDSCH includes a second DCI. In such implementations, the second DCI indicates the second resource allocation of the second set of resources for reception of at least one or multiple PUSCH. In certain implementations, the second resource allocation of the second set of resources includes an allocation of downlink resources for at least one second PDSCH.

In some implementations, the first DCI further indicates one or more search spaces associated with the second DCI transmitted in a PDCCH. In such implementations, the second DCI indicates the second resource allocation of the second set of resources for reception of the at least one or multiple PUSCH or transmission of at least one second PDSCH.

In some implementations, a set of MSBs of a TB of the PDSCH indicates the second resource allocation of the second set resources for reception of the at least one or multiple PUSCH. In other implementations, a set of LSBs of a TB of the PDSCH indicates the second resource allocation of the second set resources for reception of the at least one or multiple PUSCH.

In some implementations, the reception of the at least one or multiple PUSCH is offset from the transmission of the PDSCH by a number of symbols, where the first DCI or the PDSCH further indicates the number of symbols.

In some implementations, the processor 1102 coupled with the memory 1104 may be configured to cause the NE 1100 to identify (e.g., based on a PUSCH resource indicator) a PUSCH resource index mapping to the second set of resources, where the second set of resources is associated with a set of previously activated PUSCH resources. For example, the NE 1100 may transmit MAC-CE signaling for activating specific PUSCH resources from a configured (e.g., predefined) PUSCH resource set.

In some implementations, the processor 1102 coupled with the memory 1104 may be configured to cause the NE 1100 to transmit a configuration that includes a first subset of parameters associated with the second set of resources, where the first DCI or the PDSCH includes a second subset of parameters associated with the second set of resources.

In some implementations, the capability of the UE includes support for full-duplex communications, where the transmission of the PDSCH and reception of a respective PUSCH of the at least one or multiple PUSCH is based at least in part on the capability of the UE include support for full-duplex communications.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receiving the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the received signal and obtain the transmitted data by reversing the modulation technique applied during transmission of the signal. The receiver chain 1110 may include at least one decoder for decoding/processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

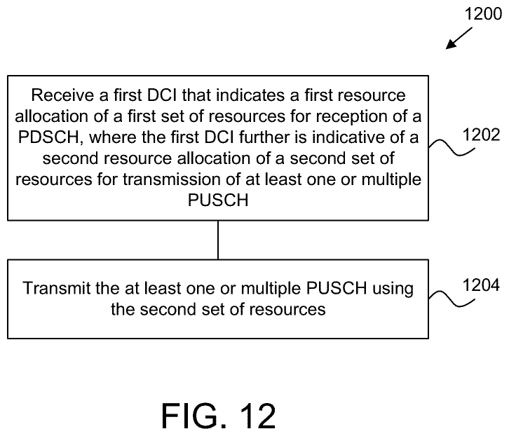

FIG. 12 illustrates a flowchart of a method 1200 in accordance with aspects of the present disclosure. The operations of the method 1200 may be implemented by a UE as described herein. In some implementations, the UE may execute a set of instructions to control the function elements of a processor to perform the described functions.

At step 1202, the method 1200 may include receiving a first DCI, wherein the first DCI indicates a first resource allocation of a first set of resources for reception of a PDSCH, and wherein the first DCI further is indicative of a second resource allocation of a second set of resources for transmission of at least one or multiple PUSCH. The operations of step 1202 may be performed in accordance with examples as described herein. In some implementations, aspects of the operations of step 1202 may be performed by a UE, as described with reference to FIG. 9.

At step 1204, the method 1200 may include transmitting the at least one or multiple PUSCH using the second set of resources. The operations of step 1204 may be performed in accordance with examples as described herein. In some implementations, aspects of the operations of step 1204 may be performed by a UE, as described with reference to FIG. 9.

It should be noted that the method 1200 described herein describes one possible implementation, and that the operations and the steps may be rearranged or otherwise modified and that other implementations are possible.

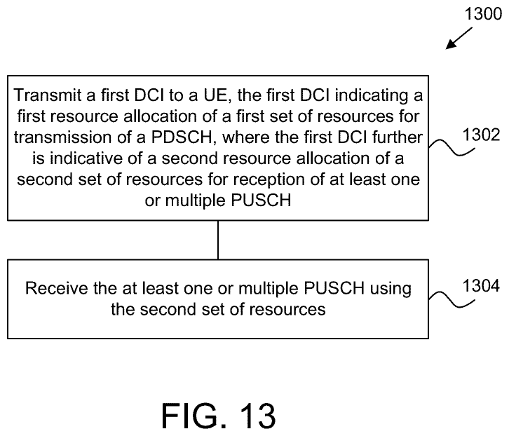

FIG. 13 illustrates a flowchart of a method 1300 in accordance with aspects of the present disclosure. The operations of the method 1300 may be implemented by a NE as described herein. In some implementations, the NE may execute a set of instructions to control the function elements of a processor to perform the described functions.

At step 1302, the method 1300 may include transmitting a first DCI to a UE, wherein the first DCI indicates a first resource allocation of a first set of resources for transmission of a PDSCH, and wherein the first DCI further is indicative of a second resource allocation of a second set of resources for at least one or multiple PUSCH. The operations of step 1302 may be performed in accordance with examples as described herein. In some implementations, aspects of the operations of step 1302 may be performed by a NE, as described with reference to FIG. 11.

At step 1304, the method 1300 may include receiving the at least one or multiple PUSCH using the second set of resources. The operations of step 1304 may be performed in accordance with examples as described herein. In some implementations, aspects of the operations of step 1304 may be performed by a NE, as described with reference to FIG. 11.

It should be noted that the method 1300 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively configured to cause the UE to:
receive a first downlink control information (DCI), wherein the first DCI indicates a first resource allocation of a first set of resources for reception of a physical downlink shared channel (PDSCH), and wherein the first DCI further is indicative of a second resource allocation of a second set of resources for transmission of at least one or multiple physical uplink shared channel (PUSCH); and
transmit the at least one or multiple PUSCH using the second set of resources.

2. The UE of claim 1, wherein the one or more processors are further individually or collectively configured to cause the UE to receive the PDSCH, wherein the received PDSCH includes a second DCI, and wherein the second DCI indicates the second resource allocation of the second set of resources for transmission of the at least one or multiple PUSCH.

3. The UE of claim 2, wherein the second resource allocation of the second set of resources comprises downlink resources for at least one second PDSCH.

4. The UE of claim 1, wherein the first DCI further indicates one or more search spaces associated with a second DCI received in a physical downlink control channel (PDCCH), and wherein the second DCI indicates the second resource allocation of the second set of resources for transmission of the at least one or multiple PUSCH or reception of at least one second PDSCH.

5. The UE of claim 1, wherein a set of least significant bits (LSBs) of a transport block (TB) of the PDSCH indicates the second resource allocation of the second set of resources for transmission of the at least one or multiple PUSCH.

6. The UE of claim 1, wherein the transmission of the at least one or multiple PUSCH is offset from the reception of the PDSCH by a number of symbols, and wherein the first DCI or the PDSCH further indicates the number of symbols.

7. The UE of claim 1, wherein the one or more processors are further individually or collectively configured to cause the UE to identify a PUSCH resource index mapping to the second set of resources, and wherein the second set of resources is associated with a set of previously activated PUSCH resources.

8. The UE of claim 1, wherein the one or more processors are further individually or collectively configured to cause the UE to receive a configuration that includes a first subset of parameters associated with the second set of resources, and wherein the first DCI or the PDSCH includes a second subset of parameters associated with the second set of resources.

9. The UE of claim 1, wherein a capability of the UE includes support for full-duplex communications, and wherein the reception of the PDSCH and transmission of a respective PUSCH of the at least one or multiple PUSCH is based at least in part on the capability of the UE includes support for full-duplex communications.

10. A method performed by a user equipment (UE), the method comprising:
receiving a first downlink control information (DCI), wherein the first DCI indicates a first resource allocation of a first set of resources for reception of a physical downlink shared channel (PDSCH), and wherein the first DCI further is indicative of a second resource allocation of a second set of resources for transmission of at least one or multiple physical uplink shared channel (PUSCH); and
transmitting the at least one or multiple PUSCH using the second set of resources.

11. A base station for wireless communication, comprising:
one or more memories; and
one or more processors coupled with the one or more memories and individually or collectively configured to cause the base station to:
transmit a first downlink control information (DCI) to a user equipment (UE), wherein the first DCI indicates a first resource allocation of a first set of resources for transmission of a physical downlink shared channel (PDSCH), and wherein the first DCI further is indicative of a second resource allocation of a second set of resources for reception of at least one or multiple physical uplink shared channel (PUSCH); and
receive the at least one or multiple PUSCH using the second set of resources.

12. The base station of claim 11, wherein the one or more processors are further individually or collectively configured to cause the base station to transmit the PDSCH, wherein the transmitted PDSCH includes a second DCI, and wherein the second DCI indicates the second resource allocation of the second set of resources for reception of at least one or multiple PUSCH.

13. The base station of claim 12, wherein the second resource allocation of the second set of resources comprises downlink resources for at least one second PDSCH.

14. The base station of claim 11, wherein the first DCI further indicates one or more search spaces associated with a second DCI transmitted in a physical downlink control channel (PDCCH), and wherein the second DCI indicates the second resource allocation of the second set of resources for reception of the at least one or multiple PUSCH or transmission of at least one second PDSCH.

15. The base station of claim 11, wherein a set of most significant bits (MSBs) of a transport block (TB) of the PDSCH indicates the second resource allocation of the second set resources for reception of the at least one or multiple PUSCH.

16. The base station of claim 11, wherein the reception of the at least one or multiple PUSCH is offset from the transmission of the PDSCH by a number of symbols, and wherein the first DCI or the PDSCH further indicates the number of symbols.

17. The base station of claim 11, wherein the one or more processors are further individually or collectively configured to cause the base station to identify a PUSCH resource index mapping to the second set of resources, and wherein the second set of resources is associated with a set of previously activated PUSCH resources.

18. The base station of claim 11, wherein the one or more processors are further individually or collectively configured to cause the base station to transmit a configuration that includes a first subset of parameters associated with the second set of resources, and wherein the first DCI or the PDSCH includes a second subset of parameters associated with the second set of resources.

19. The base station of claim 11, wherein a capability of the UE includes support for full-duplex communications, and wherein the transmission of the PDSCH and reception of a respective PUSCH of the at least one or multiple PUSCH is based at least in part on the capability of the UE include support for full-duplex communications.

20. A method performed by a base station, the method comprising:
transmitting a first downlink control information (DCI) to a user equipment (UE), wherein the first DCI indicates a first resource allocation of a first set of resources for transmission of a physical downlink shared channel (PDSCH), and wherein the first DCI further is indicative of a second resource allocation of a second set of resources for at least one or multiple physical uplink shared channel (PUSCH); and
receiving the at least one or multiple PUSCH using the second set of resources.
